(19) United States
(12) Patent Application Publication
(10) Pub. No.: US 2009/0269115 A1
(43) Pub. Date: Oct. 29, 2009

(54) IMAGE FORMING APPARATUS

(76) Inventors: Masahiro SATO, Ebina-shi (JP); Atsuyuki KITAMURA, Ebina-shi (JP); Junichi MURAKAMI, Ebina-shi (JP); Tetsuji OKAMOTO, Ebina-shi (JP); Koichi WATANABE, Ebina-shi (JP); Shuichi NISHIDE, Ebina-shi (JP)

Correspondence Address: MORGAN LEWIS & BOCKIUS LLP, 1111 PENNSYLVANIA AVENUE NW, WASHINGTON, DC, 20004, US

(21) Appl. No.: 12/409,051

(22) Filed: Mar. 23, 2009

(30) Foreign Application Priority Data
Apr. 28, 2008 (JP) 2008-116750

(51) Int. Cl. G03G 15/00

(52) U.S. Cl. 399/405; 399/400

(57) ABSTRACT

An image forming apparatus includes: an image carrier; a developing device that supplies one of plural color developers to the image carrier and forms a developer image; a transfer unit that transfers the developer image to a recording medium; a fixing unit that fixes the developer image; a transport path for transporting the recording medium from a supply position to an exit port; a return path for transporting the recording medium subjected to the fixing process to a position upstream of the transfer unit for performing subsequent processes on a developer image of another color developer; and a plane, including a junction of the transport path and the return path and a center of rotation of the developing device, being provided at a 90°—or wider angle with respect to a plane including a transfer position and the center of rotation of the developing device, on an upstream side of the another plane in a transport direction of the recording medium.

### CROSS-REFERENCE TO RELATED APPLICATIONS

This application is based on and claims priority under 35 USC 119 from Japanese Patent Application No. 2008-116750 filed Apr. 28, 2008,

### BACKGROUND

### Technical Field

The present invention relates to an image forming apparatus.

### SUMMARY

An aspect of the present invention is an image forming apparatus including: an image carrier; a developing device that supplies one of plural color developers to the image carrier by rotating and visualizes an electrostatic latent image carried on the image carrier to a developer image; a transfer unit that transfers the developer image carried on the image carrier to a recording medium; a fixing unit that fixes the developer image transferred by the transfer unit to the recording medium; a transport path for transporting the recording medium from a supply position through the transfer unit and the fixing unit to an exit port; a return path for transporting the recording medium to which the developer image has been fixed by the fixing unit to a position upstream of the transfer unit on the transport path for performing subsequent transfer and fixing processes on a developer image of another one of the plural color developers formed by the developing device, the transport path and the return path being provided to circulate around the developing device; and a plane, including a junction of the transport path and the return path and a center of rotation of the developing device, being provided at a 90°—or wider angle with respect to another plane including a transfer position for transfer of the developer image to the recording medium by the transfer unit and the center of rotation of the developing device, on an upstream side of the another plane in a transport direction of the recording medium.

### BRIEF DESCRIPTION OF THE DRAWINGS

An exemplary embodiment of the present invention will be described in detail based on the following figures, wherein:

FIG. 1 is a cross-sectional view schematically showing the structure of an image forming apparatus according to an exemplary embodiment of the present invention;

FIG. 2 is an explanatory view schematically showing correction of a transporting direction of a recording medium with a correction roller;

FIG. 3 schematically illustrates the positional relation between a circular path and its peripheral elements in the image forming apparatus shown on FIG. 1;

FIG. 4 is a cross-sectional view schematically showing the structure of a modification of the image forming apparatus according to the exemplary embodiment of the present invention; and

FIG. 5 schematically illustrates the positional relation between the circular path and its peripheral elements in the modification of the image forming apparatus shown in FIG. 4.

### DETAILED DESCRIPTION

Next, an exemplary embodiment of the present invention will be described based on the drawings.

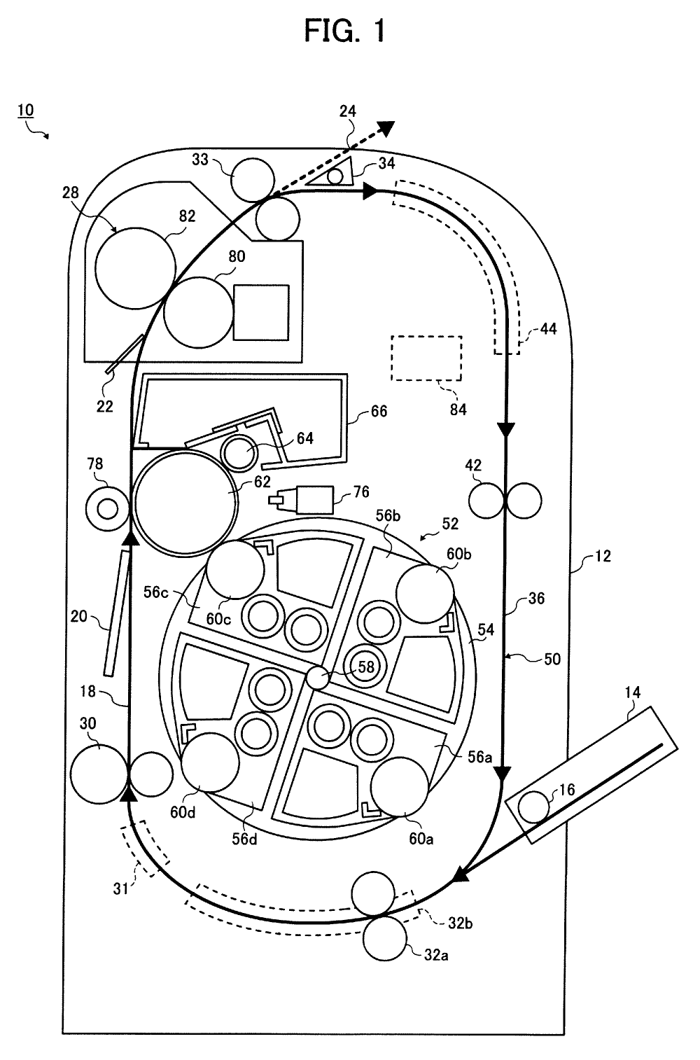

FIG. 1 schematically shows the structure of an image forming apparatus 10 according to an exemplary embodiment of the present invention. The image forming apparatus 10 has an image forming apparatus main body 12, and e.g. a sheet supply unit 14 is provided on the front side of the image forming apparatus main body 12 (right side in FIG. 1). Note that the sheet supply unit 14 may be integrally provided in the image forming apparatus main body 12, or may be attached/removed to/from the image forming apparatus main body 12. Further, a manual sheet feed part in place of the sheet supply unit 14 may be provided on the front side of the image forming apparatus main body 12.

The sheet supply unit 14 is provided with a pickup roller 16 to pick up a recording medium such as a recording sheet from the sheet supply unit 14 on the image forming apparatus main body 12 side. The pickup roller 16, driven by a driving part (not shown), is rotated to supply the recording medium toward a transport path 18.

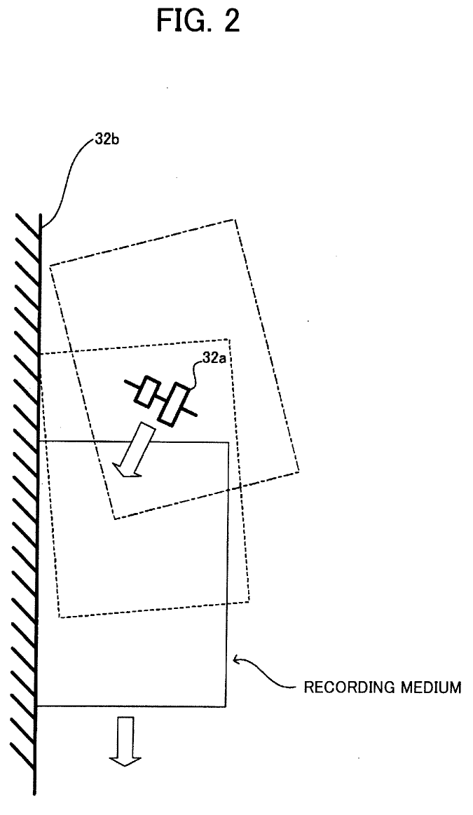

The transport path 18 is a recording medium path provided with guide members 20 and 22 to guide a recording medium from the pickup roller 16 to an exit port 24. The transport path 18 has a part approximately vertically extending on the rear side of the image forming apparatus main body 12 (left side FIG. 1). On the transport path 18, an image carrier 62 and a transfer roller 78 to be described later are provided on the upstream side of a fixing device 28, and a registration roller (timing roller) 30 is provided on the upstream side of the image carrier 62 and the transfer roller 78. A sensor 31 which is e.g. a line sensor to detect a length, a width and passing timing of the recording medium, is provided on the upstream side of the registration roller 30, and a correction roller 32a and a guide member 32b are provided on the upstream side of the sensor 31. As shown in FIG. 2, the correction roller 32a transports the recording medium toward the guide member 32b such that a side edge of the recording medium is in contact with the guide member 32b. The correction roller 32a moves the recording medium along the guide member 32b thereby corrects a transporting direction of the recording medium. Further, an exit roller 33 is provided in the vicinity of the exit port 24 on the transport path 18.

Accordingly, the recording medium picked up with the pickup roller 16 from the sheet supply unit 14 is guided to the transport path 18, transported with the correction roller 32a while the transporting direction is corrected, its length, width and the like are detected by the sensor 31, and the recording medium is temporarily stopped with the registration roller 30. Then, e.g. a black color developer image is transferred in a transfer position between the image carrier 62 and the transfer roller 78 to be described later, at predetermined timing. The transferred black developer image is fixed by the fixing device 28, and the recording medium is output with the exit roller 33 from the exit port 24.

Note that in the case of color printing, the recording medium is returned to a return path three times. That is, the transport path 18 is branched to two paths on the downstream side of the exit roller 33, a switching device 34 is provided in the branching portion, and a return path 36 returned from the branching portion again to the transport path 18 is formed. The return path 36 has a part approximately vertically extending on the front side of the image forming apparatus main body 12 (right side in FIG. 1). The return path 36 is provided with a transport roller 42, and a sensor 44 to detect the length of the recording medium is provided on the upstream side of the transport roller 42 on the return path 36. In the case of color printing, the switching device 34 is switched to the side to open the return path 36, then the recording medium is guided to the return path 36, then the length of the recording medium is detected by the sensor 44. The recording medium is transported with the correction roller 32a while the transporting direction is corrected, and the width of the recording medium is detected by the sensor 31. The recording medium is passed through the registration roller 30, the transfer position between the image carrier 62 and the transfer roller 78 and the fixing device 28 four times, and is output from the exit sort 24.

Note that the transport path 18 and the return path 36 form a circular path 50 to transport the recording medium passed through the fixing device 28 again to the fixing device 28.

The image forming apparatus main body 12 is provided with a rotary developing device 52 in e.g. an approximately central position. The rotary developing device 52, having developing units 56a, 56b, 56c and 56d respectively forming yellow, magenta, cyan and black color toner images in a developing device main body 54, rotates counterclockwise about a center of the rotary developing device 58 as a center of rotation. The developing units 56a, 56b, 56c and 56d have developing rollers 60a, 60b, 60c and 60d.

The image carrier 62 which is e.g. a photoreceptor is provided in contact with the rotary developing device 52, and a part of the periphery of the respective developing rollers 60a, 60b, 60c and 60d, not in contact with the image carrier 62, is projected from the outer periphery of the developing device main body 54 in a radial direction by e.g. 2 mm. Further, tracking rollers (not shown), having a diameter slightly larger than that of the developing rollers 60a, 60b, 60c and 60d, are provided on both ends of each of the developing rollers 60a, 60b, 60c and 60d, such that the tracking rollers are rotated coaxially with the developing rollers 60a, 60b, 60c and 60d. That is, the tracking rollers of the developing rollers 60a, 60b, 60c and 60d are in contact with flanges (not shown) provided on both ends of the image carrier 62, thereby a predetermined gap is formed between the developing rollers 60a, 60b, 60c and 60d and the image carrier 62, and a latent image on the image carrier 62 is developed with respective color developers.

A charging device 64 which is e.g. a charging roller to uniformly charge the image carrier 62 is provided above the image carrier 62. Further, an image carrier cleaner 66 is in contact with the image carrier 62 on the upstream side of the charging device 64 in a rotation direction of the image carrier 62. The image carrier cleaner 66 scrapes off a developer remaining on the image carrier 62 after e.g. first transfer.

Note that the developer contained in the developing units 56a, 56b, 56c and 56d is e.g. a two-component developer including non-magnetic toner and magnetic carrier in which the non-magnetic toner is attached to the periphery of the magnetic carrier.

Hereinbelow, when a description is made using one of plural constituent elements such as the developing units 56a, 56b, 56c and 56d as a representative unit, it will be simply referred to as e.g. a “developer 56”.

An optical writing device 76 to write a latent image with a light ay such as a laser beam on the image carrier 62 charged by the charging device 64 is provided above the rotary developing device 52. Further, the transfer roller 78 to transfer a developer image visualized by the rotary developing device 52 to the recording medium in the transfer position is provided on the rear side of the image carrier 62.

The fixing device 28 is provided on the downstream side of the transfer position on the transport path 18. The fixing device 28, having a heating roller 80 and a pressure roller 82, applies heat and pressure to the developer image transferred to the recording medium with the image carrier 62 and the transfer roller 78, thereby fixes the developer image to the recording medium upon each transfer, and transports the recording medium.

Further, the image forming apparatus 10 includes a controller 84 having a CPU and a memory (neither shown), to control the respective constituent elements of the image forming apparatus 10 and control the shape and position of a developer image transferred to a recording medium.

Next, the positional relation between the circular path 50 on which a recording medium is transported and its peripheral elements will be described in detail.

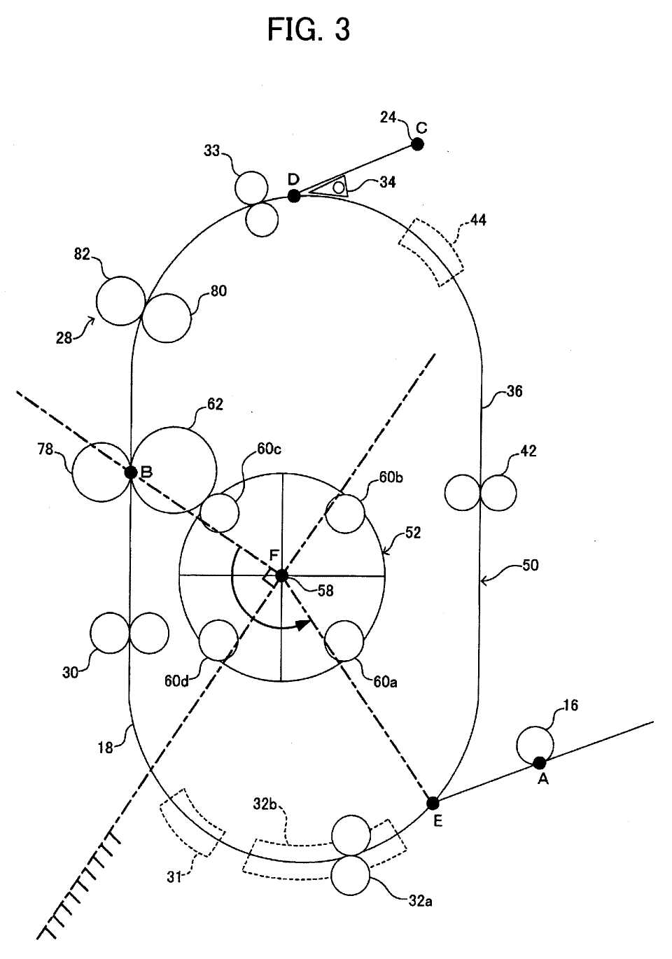

FIG. 3 schematically illustrates the positional relation between the circular path 50 and its peripheral elements in the image forming apparatus 10 shown in FIG. 1.

As described above, the transport path 18 is a recording medium path on which a recoding medium is transported from the pickup roller 16 (point A) through the transfer position (point B) between the image carrier 62 and the transfer roller 78 to the exit tort 24 (point C) in one direction. The return path 36 is a recording medium path on which the recording medium is transported from a branching point in which the switching device 34 is provided and the recording medium path is branched to two paths (point D) to a position in which the branched recording medium path is combined with the transport path 18 (point E) in one direction. Further, the circular path 50 is formed such that the recording medium is transported from the junction point (point E) between the transport path 18 and the return path 36 through the transfer position (point B) and the branching point (point D), again to the junction point (point E).

The junction point (point E) is provided such that a plane including the junction point (point E) and the center of the rotary developing device 58 (point F) is set at a 90°—or wider angle with respect to a plane including the transfer position (point B) and the center of the rotary developing device 58 (point F) from the transfer position (point B) on the upstream side in the transporting direction of the recording medium transported on the transport path 18.

The registration roller 30 is provided such that a plane including a rotation axis of the registration roller 30 and the center of the rotary developing device 58 (point F) is set at a 90°—or narrower angle with respect to a plane including the transfer position (point B) and the center of the rotary developing device 58 (point F) from the transfer position (point B) on the upstream side in the transporting direction of the recording medium transported on the transport path 18.

The correction roller 32a and the guide member 32b are provided between the registration roller 30 and the junction point (point E). The sensor 31 is provided on the upstream side of the registration roller 30 on the transport path 18 and on the downstream side of the correction roller 32a and the guide member 32b on the transport path 18.

Next, the operation (color printing) of the exemplary embodiment of the present invention will be described.

When an image forming signal is sent, the image carrier 62 is uniformly charged by the charging device 64, and a light ray corresponding to a yellow image is emitted based on the image signal from the optical writing device 76 to the charged image carrier 62. The light ray from the optical writing device 76 exposes the surface of the image carrier 62, thus an electrostatic latent image is formed.

The electrostatic latent image carried on the image carrier 62 is developed with the yellow developer supplied to the developing roller 60a of the rotary developing device 52, and transferred to a recording medium supplied from the sheet supply unit 14.

Note that the recording medium supplied from the sheet supply unit 14 is transported with the correction roller 32a toward the guide member 32b thereby the transporting direction is corrected. The length (initial length), width and passing timing of the recording medium are detected by the sensor 31, and the recording medium is transported toward a position between the Image carrier 63 and the transfer roller 78 at predetermined timing.

The recording medium on which the yellow developer image has been transferred is guided to the fixing device 28. Then heat and pressure are applied to the recording medium with the heating roller 80 and the pressure roller 82, thereby the developer image is fixed to the recording medium. The recording medium to which the yellow developer image is fixed is guided by the switching device 34 to the return path 36, then the length contracted by the heat of the fixing device 28 is detected by the sensor 44, and again returned to the transport path 18. The developer remaining on the image carrier 62 is removed by the image carrier cleaner 66.

The recording medium returned to the transport path 18 is transported with the correction roller 32a toward the guide member 32b, thereby the transporting direction is corrected, then the width and the passing timing of the recording medium are detected by the sensor 31, and the recording medium is transported toward the position between the image carrier 62 and the transfer roller 78 at predetermined timing.

Then, the developing device main body 54 of the rotary developing device 52 is rotated, then the image carrier 62 is uniformly charged by the charging device 64, and a light ray corresponding to a magenta image is emitted based on the image signal from the optical writing device 76 to he charged image carrier 62. For example, the controller 84 controls the shape (length and width) of an electrostatic latent image and a writing position of the electrostatic latent image by the optical writing device 76, and the like, based on the result of detection by the sensor 44 and the sensor 31. The light ray from the optical writing device 76 exposes the surface of the image carrier 62, thus an electrostatic latent image is formed.

The electrostatic latent image carried on the image carrier 62 is developed with the magenta developer supplied to the developing roller 60b of the rotary developing device 52, and overlay-transferred to the recording medium returned to the transport path 18. The recording medium on which the magenta developer image has been transferred is guided to the fixing device 28, and the developer image is fixed to the recording medium with the heating roller 80 and the pressure roller 82. The recording medium on which the magenta developer image has been fixed is guided by the switching device 34 to the return path 36, and again returned to the transport path 18.

The developer remaining on the image carrier 62 is removed by the image carrier cleaner 66.

As the recording medium on which an image is formed is returned to the return path 36 three times, as in the case of the yellow and magenta developer images, developer images developed with the cyan and black developers are fixed to the recording medium with the fixing device 28. Then the recording medium on which a color image formed with overlaid developer images is fixed is output by she switching device 34 from the exit port 24.

Next, a modification of the image forming apparatus 10 will be described.

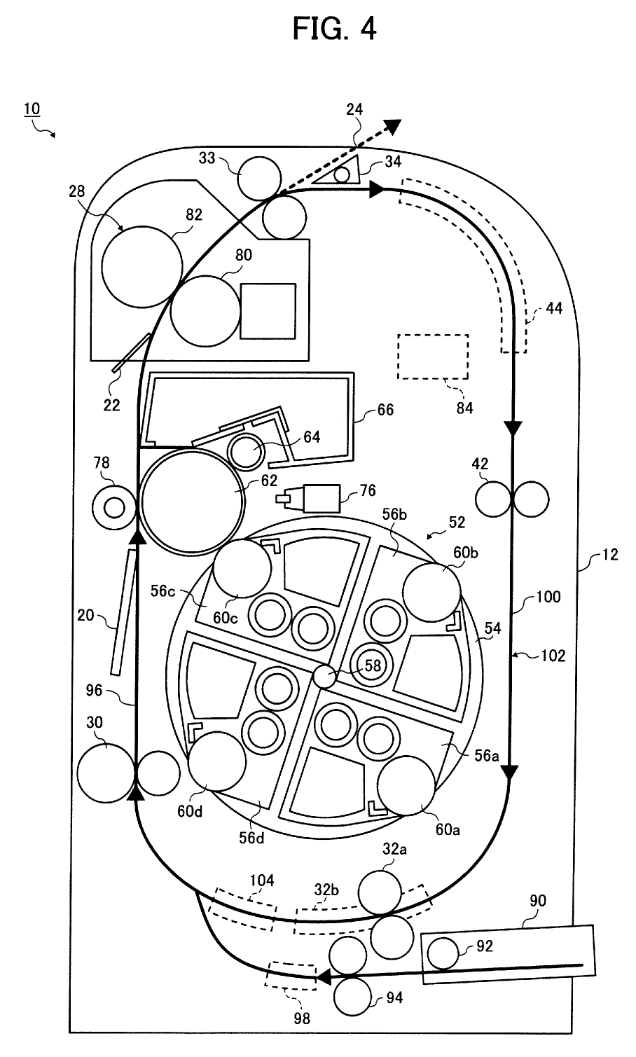

FIG. 4 schematically shows the structure of the modification of the image forming apparatus 10. Note that in the modification of the image forming apparatus 10, constituent elements substantially the same as those of the image forming apparatus 10 shown in FIG. 1 have the same reference numerals.

A sheet supply unit 90 is provided in a front-side lower part (right lower side in FIG. 4) of the image forming apparatus main body 12. The sheet supply unit 90 is provided with a pickup roller 92 to pick up a recording medium from the sheet supply unit 90. The pickup roller 92, driven by a driving part (not shown), is rotated to supply a recording medium toward a transport roller 94. The transport roller 94 transports the recording medium toward the registration roller 30.

A transport path 96 is a recording medium path from the pickup roller 92 to the exit port 24. The transport path 96 has a part approximately vertically extending on the rear side (left side in FIG. 4) of the image forming apparatus main body 12. A sensor 98 is provided on the upstream side of the registration roller 30 on the transport path 96 and on the downstream side of the transport roller 94 on the transport path 96. The sensor 98 detects the length, the width and the passing timing of the recording medium.

A return path 100 is a recording medium path which returns from the branching point ion which the switching device 34 is provided to the transport path 96 again. The return path 100 has a part approximately vertically extending on the front side (right side in FIG. 4) of the image forming apparatus main body 12. Note that the transport path 96 and the return path 100 form a circular path 102 to transport the recording medium passed through the fixing device 28 again to the fixing device 28.

A sensor 104 which is e.g. a line sensor to detect the width and the passing timing of the recording medium is provided on the upstream side of the registration roller 30 on the return path 100. The correction roller 32a and the guide member 32b are provided on the upstream side of the sensor 104 on the return path 100.

Next, the positional relation between the circular path 102 on which the recording medium is transported and its peripheral elements will be described in detail.

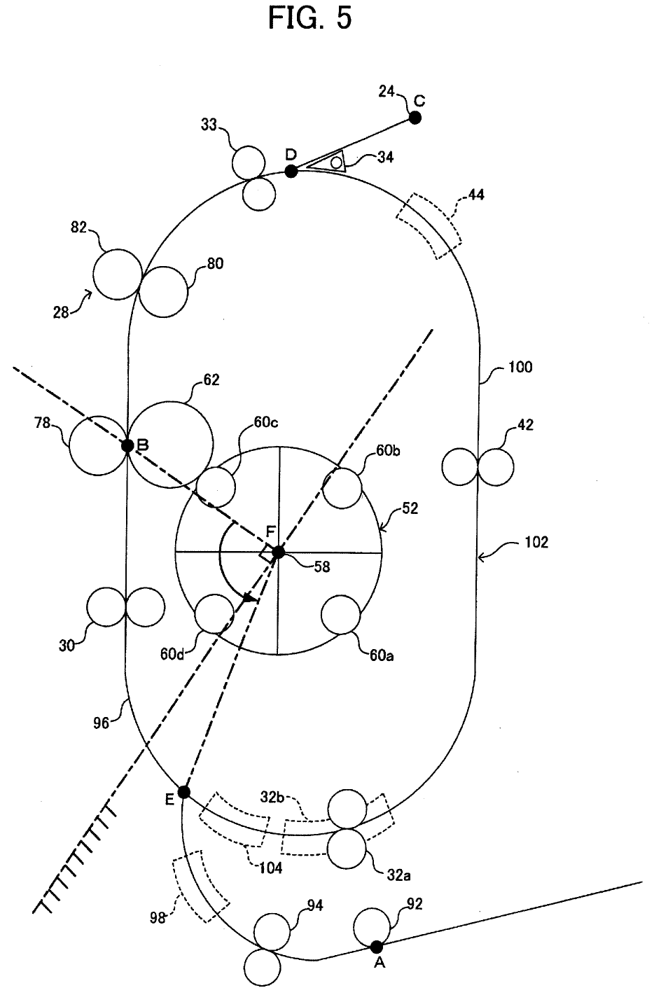

FIG. 5 schematically illustrates the positional relation between the circular path 102 and its peripheral elements in the modification of the image forming apparatus 10 shown in FIG. 4.

As described above, the transport path 96 is a recording medium path on which a recording medium 4s transported from the pickup roller 92 (point A) through the transfer position (point B) between the image carrier 62 and the transfer roller 78 to the exit port 24 (point C in FIG. 2) in one direction. The return path 100 is a recording medium path on which the recording medium is transported from the branching point (point D) in which the switching device 34 is provided and the recording medium path is branched to two paths to the position in which the branched path is combined with the transport path 96 (point E) in one direction. The circular path 102 is formed such that the recording medium is transported from the junction point (point E) between the transport path 96 and the return path 100 through the transfer position (point B) and the branching point (point D), again to the junction point (point E).

The junction point (point E) is provided such that a plane including the junction point (point E) and the center of the rotary developing device 58 (point F) is set at a 90°—or wider angle with respect to a plane including the transfer position (point B) and the center of the rotary developing device 58 (point F) from the transfer position (point B) on the upstream side in the transporting direction of the recording medium transported on the transport path 96.

The registration roller 30 is provided such that a plane including the rotation axis of the registration roller 30 and the center of the rotary developing device 58 (point F) is set at a 90°—or narrower angle with respect to a plane including the transfer position (point B) and the center of the rotary developing device 58 (point F) from the transfer position (point B) on the upstream side in the transporting direction of the recording medium transported on the transport path 96.

The correction roller 32a and the guide member 32b are provided between the registration roller 30 and the junction point (point E) on the return path 100. The sensor 98 is provided on the upstream side of the registration roller 30 on the transport path 96. The sensor 104 is provided on the upstream side of the registration roller 30 on the return path 100 and on the downstream side of the correction roller 32a and the guide member 32b on the return path 100.

Next, the operation (color printing) of the modification of the image forming apparatus 10 will be described.

When an image forming signal is sent, the image carrier 62 is uniformly charged by the charging device 64, and a light ray corresponding to a yellow image is emitted based on the image signal from the optical writing device 76 to the charged image carrier 62. The light ray from the optical writing device 76 exposes the surface of the image carrier 62, thus an electrostatic latent image is formed.

The electrostatic latent image carried on the image carrier 62 is developed with the yellow developer supplied to the developing roller 60a of the rotary developing device 52, and transferred to a recording medium supplied from the sheet supply unit 90.

Note that the length (initial length), width and passing timing of the recording medium supplied from the sheet supply unit 90 are detected by the sensor 98 and the recording medium is transported toward the position between the image carrier 62 and the transfer roller 78 at predetermined timing.

The recording medium on which the yellow developer image has been transferred is guided to the fixing device 28. Then heat and pressure are applied to the recording medium with the heating roller 80 and the pressure roller 82, thereby the developer image is fixed to the recording medium. The recording medium to which the yellow developer image is fixed is guided by the switching device 34 to the return path 100, and then the length contracted by the heat of the fixing device 28 is detected by the sensor 44. The recording medium is transported with the correction roller 32a toward the guide member 32b, thereby the transporting direction is corrected Then the width and the passing timing of the recording medium are detected by the sensor 104, and the recording medium is again returned to the transport path 96. Then the developer remaining on the image carrier 62 is removed by the image carrier cleaner 66.

The recording medium returned to the transport path 96 is transported to the position between the image carrier 62 and the transfer roller 78 at predetermined timing with the registration roller 30.

Then, the developing device main body 54 of the rotary developing device 52 is rotated, then the image carrier 62 is uniformly charged by the charging device 64, and a light ray corresponding to a magenta image is emitted based on the image signal from the optical writing device 76 to the charged image carrier 62. For example, the controller 84 controls the shape (length and width) of an electrostatic latent image and a writing position of the electrostatic latent image by the optical writing device 76, and the like, based on the result of detection by the sensor 98, the sensor 44 and the sensor 104 The light ray from the optical writing device 76 exposes the surface of the image carrier 62, thereby an electrostatic latent image is formed.

The electrostatic latent image carried on the image carrier 62 is developed with the magenta developer supplied to the developing roller 6Db of the rotary developing device 52, and overlay-transferred to the recording medium returned to the transport path 96. The recording medium on which the magenta developer image has been transferred is guided to the fixing device 28, and the developer image is fixed to the recording medium with the heating roller 80 and the pressure roller 82. The recording medium on which the magenta developer image has been fixed is guided by the switching device 34 to the return path 100, and again returned to the transport path 96.

The developer remaining on the image carrier 62 is removed by the image carrier cleaner 66.

As the recording medium on which an image is formed is returned to the return path 36 three times, as in the case of the yellow and magenta developer images, developer images developed with the cyan and black developers are fixed to the recording medium with the fixing device 28. Then the recording medium on which a color image formed with overlaid developer images is fixed is discharged by the switching device 34 from the exit port 24.

In this manner, in the image forming apparatus in which a developer image is fixed plural times to a recording medium circulating around the rotary developing device 52, since the size of the recording medium differs upon each circulation, it is necessary to accurately detect the size of the recording medium on which a developer image is not transferred, and the positional relation between the supply position of the recording medium and the developer image transfer position is important in image formation precision (prevention of color shift).

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising
an image carrier;
a developing device that supplies one of a plurality of color developers to the image carrier by rotating and visualizes an electrostatic latent image carried on the image carrier to a developer image;
a transfer unit that transfers the developer image carried on the image carrier to a recording medium;
a fixing unit that fixes the developer image transferred by the transfer unit to the recording medium;
a transport path for transporting the recording medium from a supply position through the transfer unit and the fixing unit to an exit port;
a return path for transporting the recording medium to which the developer image has been fixed by the fixing unit to a position upstream of the transfer unit on the transport path for performing subsequent transfer and fixing processes on a developer image of another one of the plurality of color developers formed by the developing device, the transport path and the return path being provided to circulate around the developing device; and
a plane, including a junction of the transport oath and the return path and a center of rotation of the developing device, being provided at a 90°—or wider angle with respect to another plane include a transfer position for transfer of the developer image to the recording medium by the transfer unit and the center of rotation of the developing device, on an upstream side of the another plane in a transport direction of the recording medium.

2. The image forming apparatus according to claim 1, further comprising a transporting direction correction unit that corrects the transporting direction of the recording medium on the upstream side of the transfer position on the circular path.

3. The image forming apparatus according to claim 2, further comprising:
a timing roller, provided to set a plane, including a rotation axis of the timing roller and a center of rotation of the developing device, at a 90°—or narrower angle with respect to a plane including the transfer position and the center of rotation of the developing device, from the transfer position on the upstream side in the transporting direction of the recording medium transported on the transport path, that controls timing of transport of the recording medium to the transfer position; and
a recording medium length detection unit, provided on the upstream side of the timing roller on the transport path that detects a length of the recording medium.

4. The image forming apparatus according to claim 3, further comprising a recording medium width detection unit, provided on an upstream side of the timing roller on the circular path and on a downstream side of the transporting direction correction unit on the circular path, that detects a width of the recording medium.

5. The image forming apparatus according to claim 2, further comprising:
a timing roller, provided to set a plane, including a rotation axis of the timing roller and the center of rotation of the developing device, at a 90°—and narrower angle with respect to a plane including the transfer position and the center of rotation of the developing device, from the transfer position on the upstream side in the transporting direction of the recording medium transported on the transport path, that controls timing of transport of the recording medium to the transfer position; and
a recording medium detection unit, provided on the upstream side of the timing roller on the transport path, that detects a length and a width of the recording medium.

6. The image forming apparatus according to claim 1, further comprising a controller that controls at last one of a shape and a posit n Of the developer image transferred by the transfer unit to the recording medium.

7. The image forming apparatus according to claim 2, further comprising a controller that controls an least one of a shape and a position of the developer image transferred by the transfer unit to the recording medium.

8. The image forming apparatus according to claim 3, further comprising a controller that controls at least one of a shape and a position of the developer image transferred by the transfer unit to the recording medium.

9. The image forming apparatus according to claim 4, further comprising a controller that controls at least one of a shape and a position of the developer image transferred by the transfer unit to the recording medium.

10. The image forming apparatus according to claim 5, further comprising a controller that controls at least one of a shape and a position of the developer image transferred by the transfer unit to the recording medium.

11. An image forming apparatus comprising:
an image carrier;
a developing device that supplies one of a plurality of color developers no the image carrier by rotating and visualizes an electrostatic latent image carried on the image carrier to a developer image;
a transfer unit that transfers the developer image carried on the image carrier to a recording medium in a transfer position;
a fixing unit that fixes the developer image transferred by the transfer unit to the recording medium;
a transport path for transporting the recording medium from a supply position through the transfer unit and the fixing unit to an exit port;
a return path for transporting the recording medium to which the developer image has been fixed by the fixing unit again to a position upstream of the transfer unit on the transport path for performing subsequent transfer and fixing processes on a developer image of another one of the plurality of color developers formed by the developing device;
a timing roller, provided to set a plane, including a rotation axis of the timing roller and a center of rotation of the developing device, at a 90°—or narrower angle with respect to another plane including the transfer position and the center of rotation of the developing device, on the upstream side of the transfer position in the transporting direction of the recording medium, that controls timing of transport of the recording medium to the transfer position; and
a detection unit, provided on the upstream side of the timing roller on the transport path, that detects information on at least one of a shape and a position of the recording medium,
a travel path for the recording medium formed with the transport path and the return path being provided to circulate around the developing device.
